(19) United States
(12) Patent Application Publication
(10) Pub. No.: US 2011/0165541 A1
(43) Pub. Date: Jul. 7, 2011

(54) Reviewing a word in the playback of audio data

(76) Inventor: Yong Liu, Herndon, VA (US)

(21) Appl. No.: 12/655,495

(22) Filed: Jan. 2, 2010

(51) Int. Cl. G09B 5/00

(52) U.S. Cl. 434/169; 434/307 R

(57) ABSTRACT

The present invention relates to reviewing and learning word contents of an audio file using a playback apparatus. The apparatus comprises of an audio playing means for playing the digital formatted audio file, an interrupt means for a user interrupt, and a processing means for implementing the methods of the present invention. The methods and apparatus, according to the present invention, allow the user to review and learn a word in the playback of the recorded audio file.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The present invention relates to methods and an apparatus for reviewing a word in the playback of recorded audio data in response to a user interrupt.

### BACKGROUND OF THE INVENTION

Audio playback devices are often used to play back recorded music or books. One of examples of such players is Walkman or iPod. Typically, audio data for music or books are stored as tracks either in the CD or in the hard disc of a player. A user interface on the player is provided to access a playlist, navigate to different tracks of audio data, and display information about the music or books such as artist or author names, titles, chapters, etc. In addition for entertainment purposes, audio players have also been used for language learning and exercising. With pause/forward/backward input, the player can repeatedly playback the same portion of the audio data for a user to understand the speech patterns of the audio content. Nevertheless, as a learning tool, it would be more effective to have functions that allow users to study a word in the audio data. Traditionally, a user relies on a textbook, or paragraphs on a display screen to learn the content of the audio output. However the user still has difficulties identifying the word in the audio output and understanding what it means. It is the objective of the present invention to overcome the difficulties a user has when studying the content of audio data.

### SUMMARY OF THE INVENTION

The objective of the present invention is to provide methods and an apparatus for reviewing and learning a word in the playback of an audio data in response to a user interrupt. In the preferred embodiment, the playing apparatus includes a storage device, an input device, an output device and a processor.

The storage device can be either a hard drive or a flash memory that stores an audio file, a dictionary and a collection of indicants.

The audio file records audio signals in a digital format such as MP3. It is read by the processor to playback the audio signals. The dictionary contains a list of words and their meanings such as definition, function, pronunciation, etc. It is accessed by the processor to retrieve the meaning of a word in the audio file. In order to identify the word, the apparatus provides a collection of indicants stored in a storage device. In one embodiment, each indicant is the start position of a word in the playing audio stream. In another embodiment, each indicant is a pointer that points to the memory location of a word in the playing audio stream.

The input device of the playing apparatus receives a user interrupt. In the preferred embodiment, the input device is a push button that signals the processor to pause the playback and output the meaning of the word that is being heard. The input device may also include a push button for repeating the playback of the word. In another embodiment, the input device includes a graphical user interface that includes elements for reviewing, repeating, or stepping through the words in the audio file. The output device of the playing apparatus produces sound signals. In the preferred embodiment, the output device includes a speaker; it may also include an LCD screen to display the word, its adjacent words, or the meanings of the words.

The processor of the playing apparatus includes an audio decoder, a module that implements the methods of the present invention for reviewing a word in the audio data, and a digital to analog converter (DAC). The processor reads the audio file from the storage device into a bitstream, decodes the bitstream into a Pulse Code Modulation (PCM) stream, and convert the PCM stream into analog signals. When the processor receives the interrupt signal from a user for reviewing a word in the audio file, it selects the indicant that identifies the word. Using a mapping table, the processor finds the text word that is associated with the indicant. The processor further searches the dictionary to find the meaning of the word. Finally, the processor sends the output device the output signal that represents the meaning of the word. The apparatus is operated as follows: A user presses a start button to activate the playback of an audio file. When listening to a word, the user presses a button to request the meaning of the word. The apparatus either outputs the meaning as an audio signal or displays the meaning on a display screen. The meaning includes, but not limited to the definition, function, pronunciation, illustration, etc. The apparatus may also display adjacent words and allow users to review them as well.

### BRIEF DESCRIPTION OF THE DRAWINGS

FIG. 1 is a block diagram for an apparatus used in the present invention for reviewing a word in the playback of audio data.

FIG. 2A describes one embodiment of how indicants are structured to identify words in an audio stream.

FIG. 2B describes another embodiment of how indicants are structured to identify words in an audio stream.

FIG. 3 illustrates how an apparatus used in the present invention operates.

FIG. 4 is a flow diagram for a method used in the present invention for reviewing a word in the playback of an audio data.

FIG. 5 is a flow diagram for another method used in the present invention for reviewing a word in the playback of an audio data.

FIG. 6 is a flow diagram for a method used in the present invention for constructing a collection of indicants.

FIG. 7 is a flow diagram for a method used in the present invention for reviewing a word and stepping through its adjacent words.

### DETAILED DESCRIPTION

A preferred embodiment of the invention is now described with reference to the figures, where like reference numbers indicate identical or functionally similar elements. Also in the figures, the leftmost digit of each reference number corresponds to the figure in which the reference number is first used. While specific steps, configurations and arrangements are discussed, it should be understood that this is done for illustrative purposes only. A person skilled in the relevant art will recognize the other steps; configurations and arrangements can be used without departing from the spirit and scope of the invention.

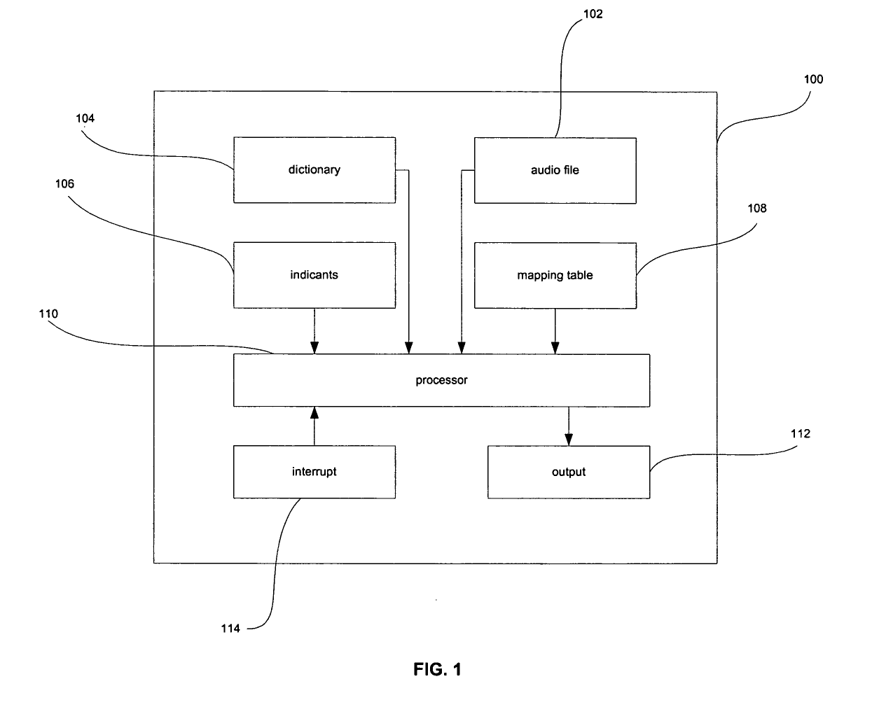

FIG. 1 illustrates components used in the present invention. An audio playing apparatus 100 includes a storage device that stores an audio file 102, a dictionary 104, a collection of indicants 106 and a mapping table 108. In the preferred embodiment, the audio file 102 is in MP3 format consisting of frames, and each frame contains five parts: header, CRC (Cyclic Redundancy Code), side information, main data and ancillary data. The dictionary 104 contains a list of words and their meanings which include, but not limited to the definition, function, pronunciation, illustration, etc. In the preferred embodiment, the dictionary is stored in a relational database such as MySQL or SQLLite. In a relational database, a relation is defined as a set of tuples that have the same attributes. A tuple usually represents an object and information about that object. Objects are typically physical objects or concepts. A relation is usually described as a table, which is organized into rows (tuples) and columns (attributes). All the data referenced by an attribute are in the same domain and conform to the same constraints.

The dictionary database has a word table (relation), and is defined as follows:

WORD

ID: NUMBER
ENTRY: VARCHAR
FUNCTION: VARCHAR
PRONUNCIATION: VARCHAR
DEFINITION: VARCHAR

where the table WORD has five columns (attributes):
ID: a number that serves as a unique identifier for the word.
ENTRY: a varchar or a text string that represents the word.
FUNCTION: a varchar or a text string that represents the grammatical function of the word.
PRONUNCIATION: a varchar or a text string that presents a rule about how the word is spoken.
DEFINITION: a varchar or a text string that provides a explanation of the word.

A sample record (row) of the table is given as follows:

| Id | Entry | Function | Pronunciation | definition |
|---|---|---|---|---|
| 1109 | rehearsal | noun | \’ri-hur’s∂l\ | 1. The act of |
| | | | | practicing in |
| | | | | preparation |
| | | | | for a public |
| | | | | performance. |
| | | | | 2. A session |
| | | | | of practice |
| | | | | for a |
| | | | | performance, |
| | | | | as of a play. |
| | | | | 3. A detailed |
| | | | | enumeration |
| | | | | or repetition |

In the preferred embodiment, the dictionary 104 is stored in a memory in the location that also houses other components of the apparatus 100. In another embodiment, the dictionary 104 is stored in a memory that is housed remotely in a different location. Similarly, the collection of indicants 106 can also be stored locally or remotely.

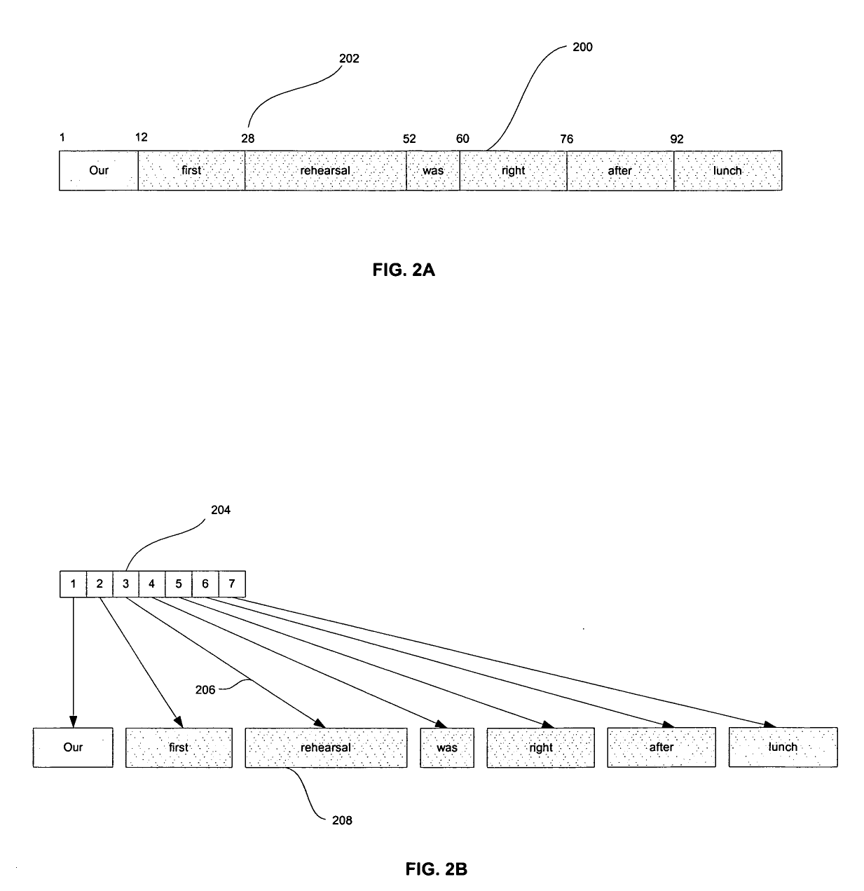

As the playing apparatus 100 plays back the audio file 102, a word in the audio file 102 can be identified by an indicant in the collection of indicants 106. FIG. 2A describes one embodiment of how the indicants are structured to identify words in an audio stream. As FIG. 2A illustrates, audio stream 200 contains 7 words “Our first rehearsal was right after lunch”. The indicant 202 specifies the start position 28 of the 3rd word “rehearsal”. When the playing apparatus 100 plays back the content between position 28 and position 52, the word in playback is “rehearsal” and is identified by position 28, namely indicant 202.

FIG. 2B describes another embodiment wherein the sequence of indicants 204 consists of pointers. The indicant 206 contains a pointer points to the 3rd word 208 of the audio stream. When playing apparatus 100 plays back the audio stream, it tracks the pointer that points to the current word in play. As FIG. 2B illustrates, pointer 3 is the current indicant when the playing apparatus 100 plays back the content 208.

FIG. 1 also shows a mapping table 108 that maintains a relation between an indicant and a word in text content representing a word in the audio stream. An example of such a relation is

28→rehearsal

where 28 is an indicant that is the start position of the word “rehearsal” as FIG. 2A shows.

In FIG. 1, the processor 110 contains a central processing unit (CPU), a decoder and a digital-to-analog converter (DAC). The CPU executes instructions that read the audio file 102 into a bitstream, decode the bitstream into a Pulse Code Modulation (PCM) stream, and convert the PCM signals into analog signals. The output device 112 receives the analog signals from the DAC module, and produces the sound signals. In one embodiment, the output device 112 includes a LCD screen; it displays a word in the audio file 102. It also displays the meaning of the word; the meaning includes, but not limited to the definition, function, pronunciation, etc.

In FIG. 1 the interrupt device 114 receives a user interrupt. In the preferred embodiment, the interrupt device 114 includes a push button. The user presses the button to interrupt the playback of the audio file 102 for reviewing or learning a word in the playback. The apparatus 100 may also include a control device for repeating the playback of the same word.

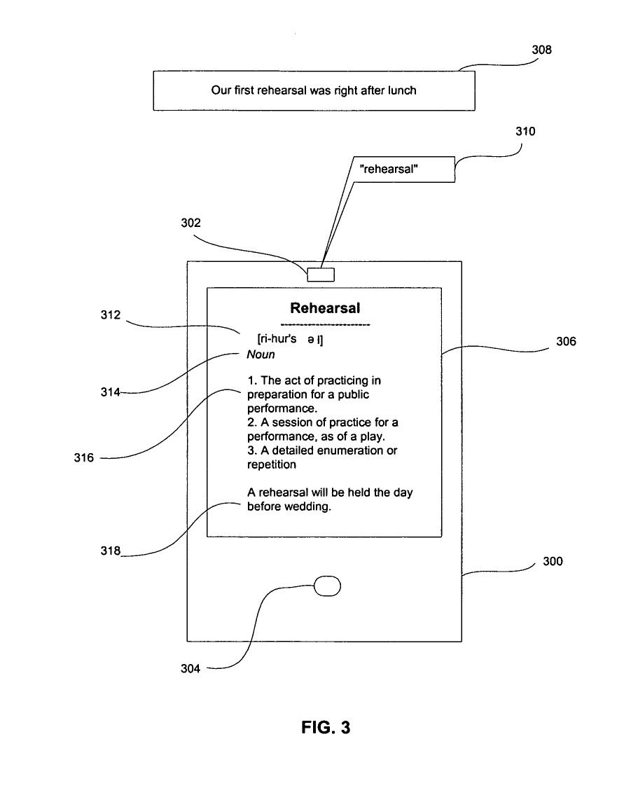

FIG. 3 illustrates how to operate the playing apparatus 100 described in FIG. 1. The apparatus has a housing 300 that houses the audio file 102, the dictionary 104, the indicants 106, the mapping table 108 and the processor 110. The output device 112 is given as a speaker 302. The interrupt device 114 is implemented as a push button 304. The apparatus 300 also includes a display device 306 for displaying the meaning of a word. As FIG. 3 illustrated, the apparatus 300 is playing back an audio 308 containing “Our first rehearsal was right after lunch”. When the word “rehearsal” is heard, the user presses the button 304 to interrupt the playback so that the apparatus 300 outputs the word “rehearsal” as sound signal 310 through the speaker 302 and displays the meaning of the word “rehearsal” on the display device 306. The meaning displayed includes the pronunciation 312, the function 314 which is “none” and the definition 316. The display device 306 may also display a sample sentence 318 containing the word “rehearsal”.

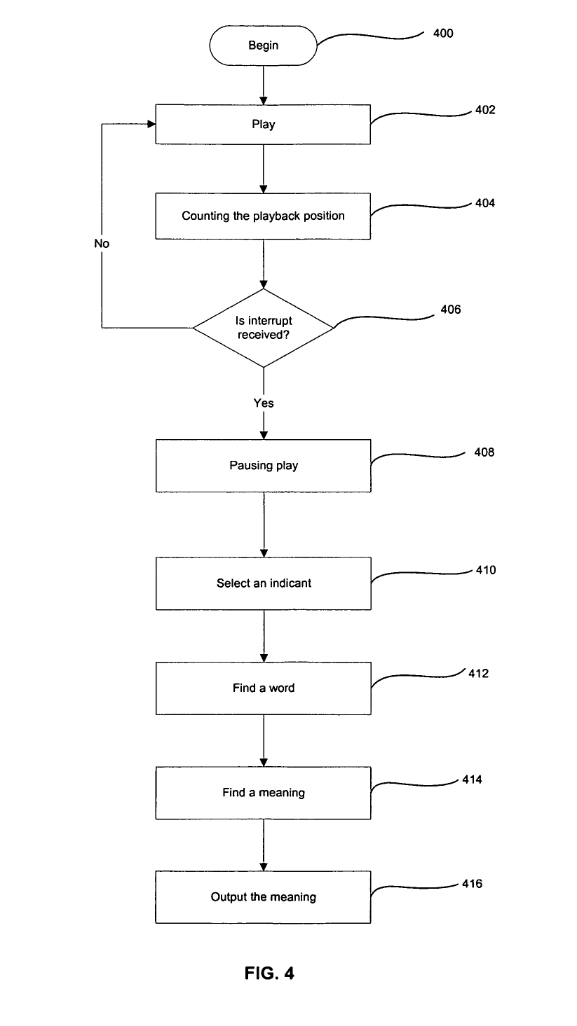

FIG. 4 is a flow diagram that describes the process for outputting the meaning of a word in an audio file. The process begins at step 400 where the apparatus 100 described in FIG. 1 is activated for playing back the audio file 102. At step 402, the apparatus 100 plays back the audio file 102, and counts the playback position at step 404. In the preferred embodiment, the playback position is the bit position in the audio bitstream that is currently been processed. The apparatus 100 repeats step 402 and step 404 until it receives an interrupt from a user at step 406. At step 408, the apparatus 100 pauses playback of the audio file 102; it then selects an indicant from the collection of indicants 106 at step 410. The indicant is selected based on the current playback position. In one embodiment, the indicant consists of a start position; it is selected so that the indicant is the greatest among the indicants that are less than the current playback position. At step 412, the apparatus 100 finds a text word from the mapping table 108 based on the indicant selected at step 410. At step 414, the apparatus 100 finds the meaning of the word through the dictionary 104. The meaning includes the definition, function, pronunciation, etc. At step 416, the apparatus 100 outputs the meaning found at step 414. The apparatus 100 may output an audio of the meaning or display it on a LCD screen.

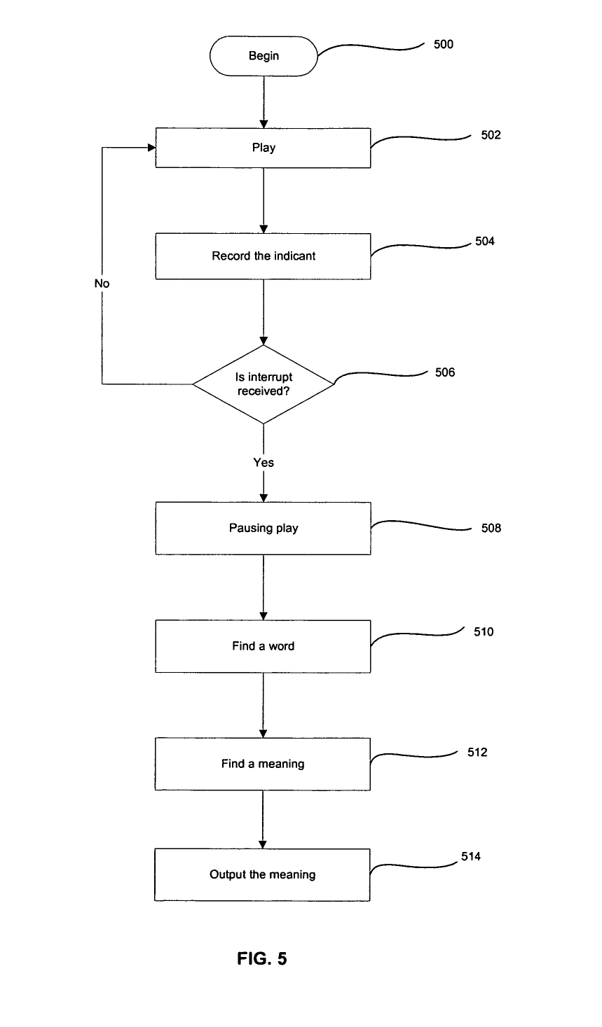

FIG. 5 is a flow diagram that describes another embodiment for outputting the meaning of a word in an audio file. The process begins at step 500 where the apparatus 100 described in FIG. 1 is activated for playing back the audio file 102. At step 502, the apparatus 100 plays back the audio file 102, and records the indicant for the current word at step 504. In one embodiment, the indicant is the start position of a word in a playing bitstream of the audio file 102 as FIG. 2A describes. In another embodiment, the indicant is the pointer that points to the memory location of a word in the audio file 102 as FIG. 2B describes. The apparatus 100 updates the indicant for the current word and stores the indicant in the memory. The apparatus 100 repeats step 502 and step 504 until it receives an interrupt from a user at step 506. At step 508, the apparatus 100 pauses playback of the audio file 102; it then finds, at step 510, a text word from the mapping table 108 based on the indicant stored at step 504. At step 512, the apparatus 100 finds the meaning of the word through the dictionary 104. At step 514, the apparatus 100 outputs the meaning.

The collection of indicants 106 in FIG. 1 is constructed by an audio signal analyzing device. In one embodiment, the analyzer consists of a voice recognizer that recognizes word contents of the audio signals and constructs a sequence of indicants. The analyzer uses the indicants to construct a mapping table between a word and a word content in the audio signal.

Voice recognition is the technology by which sounds, words or phrases spoken by humans are converted into electrical signals, and these signals are transformed into coding patterns to which meanings have been assigned. The technique has been widely used in computer-human interaction, content-based spoken audio search, speech-to-text processing, etc. The technology has been implemented as products such as WATSON from AT&T, Dragon NaturallySpeaking from Nuance Communications, ViaVoice from IBM, etc.

The most common approaches to voice recognition can be divided into two categories: template matching and feature analysis. Template matching is the simplest technique and has the highest accuracy when used properly, but it also suffers from the most limitations. As with any approach to voice recognition, the first step is for the user to speak a word or phrase into a microphone. The electrical signal from the microphone is digitized by an analog-to-digital (A/D) converter, and is stored in memory. To determine the meaning of this voice input, the computer attempts to match the input with a digitized voice sample, or template, that has a known meaning. This technique is a close analogy to the traditional command inputs from a keyboard. The program contains the input template, and attempts to match this template with the actual input using a simple conditional statement.

Since each person's voice is different, the program cannot possibly contain a template for each potential user, so the program must first be trained with a new user's voice input before that user's voice can be recognized by the program. During a training session, the program displays a printed word or phrase, and the user speaks that word or phrase several times into a microphone. The program computes a statistical average of the multiple samples of the same word and stores the averaged sample as a template in a program data structure.

A more general form of voice recognition is available through feature analysis and this technique usually leads to speaker-independent voice recognition. Instead of trying to find an exact or near-exact match between the actual voice input and a previously stored voice template, this method first processes the voice input using Fourier Transforms or Linear Predictive Coding (LPC), then attempts to find characteristic similarities between the expected inputs and the actual digitized voice input. These similarities will be present for a wide range of speakers, so the system need not be trained by each new user. For more information regarding the voice recognition technique, please refer to
Cater, John P., Electronically Hearing: Computer Speech Recognition, Howard W. Sams & Co., Indianapolis, Ind., 1984.
Fourcin, A., G. Harland, W. Barry, and V. Hazan, editors, Speech Input and Output Assessment, Ellis Horwood Limited, Chichester, UK, 1989.
Yannakoudakis, E. J., and P. J. Hutton, Speech Synthesis and Recognition Systems, Ellis Horwood Limited, Chichester, UK, 1987.

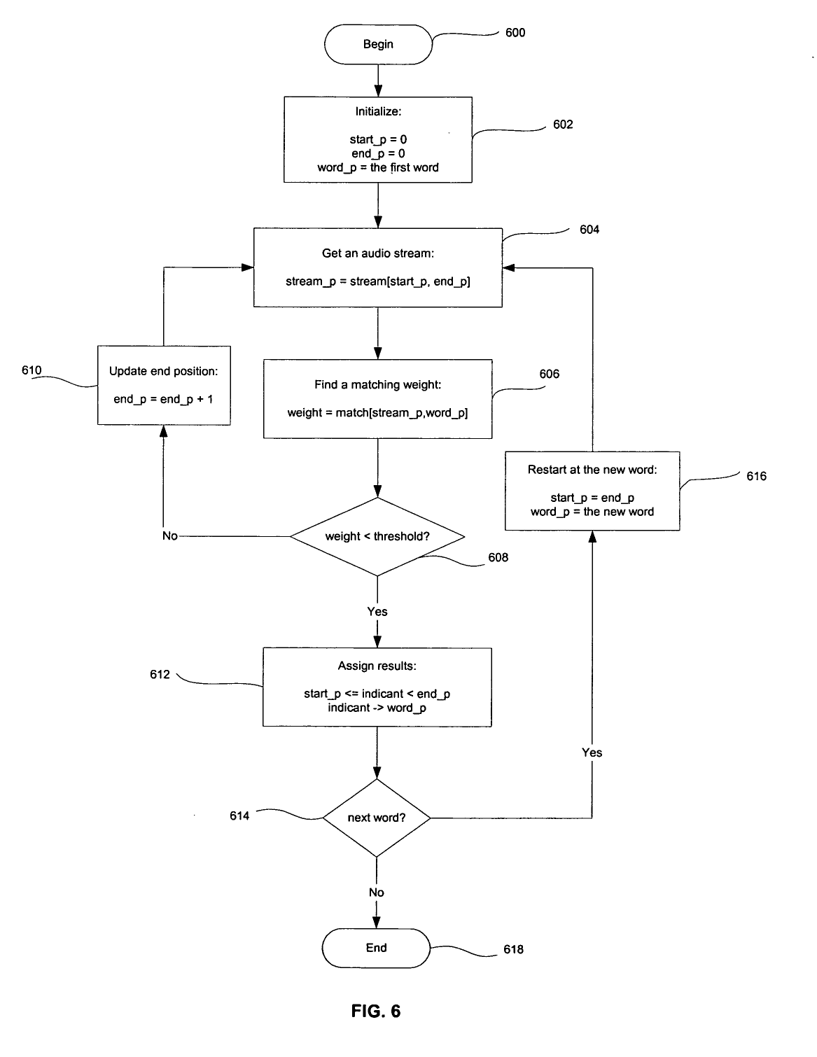

FIG. 6 is a flow diagram for constructing a collection of indicants 106 as shown in FIG. 1. The construction process starts at step 600. At step 602 the process initializes the start position pointer, end position pointer, and the word pointer so that both position pointers point at the beginning of an audio stream:

start_p=0

end_p=0

The word pointer points to the first word in a list that contains all the text words of word contents in the audio stream:

word_p=the first word

At step 604, the process selects stream_p, the portion of the audio stream between start_p and end_p:

stream_p=stream[start_p,end_p]

At step 606, the portion of the audio stream stream_p is fed into a match engine of a voice recognizer to match a word specified by word_p. The match result is returned as a weight:

weight=match[stream_p,word_p]

At step 608, the weight is compared with a predefined threshold. If the weight is not below the threshold, the process increments end_p to the next position at step 610, and repeat the step 604, 606, 608 and 610 until the weight is less than the threshold. At step 612, the process assigns the indicant as a position between start_p and end_p, preferably equal to start_p:

start_p≦indicant<end_p

and also assigns an association for the mapping table 108:

indicant→word_p

At step 614, the process looks for the next word from the word list. If there is a next word, the process updates start_p, end_p and word_p at step 616:

start_p=end_p

word_p=the next word

and repeat steps 604-616 until it completes constructing indicants for all the words in the word list and the process ends at step 618.

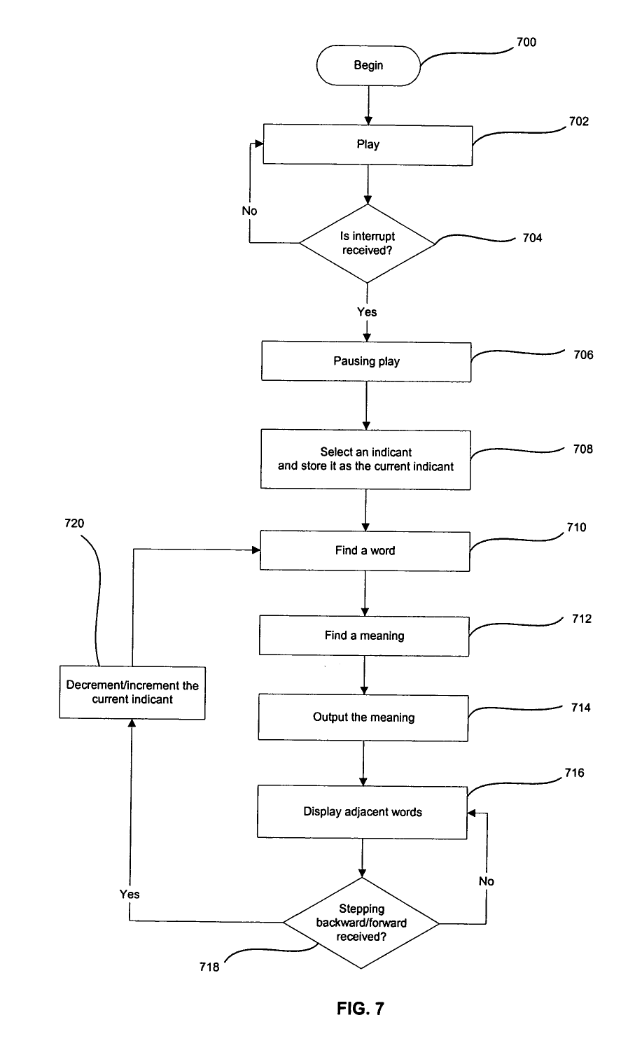

FIG. 7 is a diagram that illustrates a method for reviewing a word in an audio data and also displays words adjacent to the word.

As FIG. 7 described, the process begins playback an audio data at step 700, and continuously plays the audio data at step 702 until an interrupt is received at step 704. When the playback is interrupted at step 706, the process selects an indicant and stores it as the current indicant at step 708. The indicant is selected in the way that is describes in FIG. 4, step 410. At step 710, the process finds the word identified by the indicant. Once the word is found, the process searches the dictionary 104 described in FIG. 1 for the meaning of the word at step 712, and outputs the meaning at step 714. At step 716, the process displays words adjacent to the word found at step 710. The words are ordered according to their playback position and are maintained by the order of indicants 106. For the word found at step 710, the adjacent words are chosen by their indicants that are preceding or succeeding the indicant selected at step 708. The process continues at step 716 until it receives a stepping backward input from a user at step 718. At step 720, the process decrements the current indicant stored at step 708 by moving it to the preceding indicant. Using the updated current indicant at step 720, the process repeats step 710-716. Similarly, if a stepping forward input is received at step 718, the process increments the current indicant by moving it to the succeeding indicant at step 720, and repeats step 710-716.

Although the description above contains many specifications, these should not be construed as limiting the scope of the invention but as merely providing illustrations of some of the presently preferred embodiments of this invention. Thus the scope of the invention should be determined by the appended claims and their legal equivalents, rather than by the examples given.

I claim:

1. A method of reviewing a word in the playback of an audio data in response to an interrupt using an audio playing means, comprising:
(a) providing a dictionary of words and associated meanings stored in a storing means of said audio playing means;
(b) providing a collection of indicants stored in a storing means of said audio playing means; each of the indicants identifies a word in said audio data;
(c) providing a mapping table stored in a storing means; each entry of said mapping table maintains a relation between an indicant in said collection of indicants and a word in text content representing a word in said audio data;
(d) playing back said audio data;
(e) counting a playback position;
(f) receiving said interrupt through a interrupt means of said audio playing means;
(g) selecting an indicant among said collection of indicants based on said playback position;
(h) finding the word that is associated with said indicant through said mapping table;
(i) finding the meaning of said word through said dictionary;
(j) outputting said meaning.

2. The method of reviewing a word in the playback of an audio data as recited in claim 1 wherein each indicant of said collection of indicants is a start position of a word in a bitsteam of said audio data.

3. The method of reviewing a word in the playback of an audio data as recited in claim 1 wherein selecting an indicant for said word, comprising
(a) selecting the indicant that is greatest among indicants that are less than said playback position.

4. A method of reviewing a word in the playback of an audio data in response to an interrupt using an audio playing means, comprising:
(a) providing a dictionary of words and associated meanings stored in a storing means of said audio playing means;
(b) providing a collection of indicants stored in a storing means of said audio playing means; each of the indicants identifies a word in said audio data;
(c) providing a mapping table stored in a storing means; each entry of said mapping table maintains a relation between an indicant in said collection of indicants and a word in text content representing a word in said audio data;
(d) playing back said audio data;
(e) recording the indicant for the current word;
(f) receiving said interrupt through a interrupt means of said audio playing means;
(g) finding the word that is associated with said indicant through said mapping table;
(h) finding the meaning of said word through said dictionary;
(i) outputting said meaning.

5. The method of reviewing a word in the playback of an audio data as recited in claim 4 wherein recording the indicant for the current word, comprising
(a) finding the indicant for the current word in the playback;
(b) storing said indicant in a storing means;

6. The method of reviewing a word in the playback of an audio data as recited in claim 1 wherein the meaning found in said dictionary includes definition.

7. The method of reviewing a word in the playback of an audio data as recited in claim 1 wherein the meaning found in said dictionary includes pronunciation.

8. The method of reviewing a word in the playback of an audio data as recited in claim 1 wherein said dictionary is stored remotely.

9. The method of reviewing a word in the playback of an audio data as recited in claim 1 wherein said collection of indicants is stored remotely.

10. The method of reviewing a word in the playback of an audio data as recited in claim 1 wherein outputting said meaning comprising
(a) providing a display means;
(b) displaying said meaning;

11. The method of reviewing a word in the playback of an audio data as recited in claim 1 further comprising
(a) displaying words adjacent to said word;

12. The method of reviewing a word in the playback of an audio data as recited in claim 11 further comprising
(a) stepping to an adjacent word;
(b) outputting a meaning of said adjacent word.

13. An apparatus for reviewing a word in the playback of audio data in response to a interrupt, comprising
(a) a playback means that plays back said audio data;
(b) a storing means that stores a dictionary of words and associated meanings;
(c) a storing means that stores a collection of indicants; each of which identifies a word in said audio data;
(d) a interrupt means that receives a interrupt for reviewing a word in the playback of said audio data;
(e) a processing means that receives said interrupt signal, determines an indicant among said indicants, finds a word that is identified by said indicant, and finds a meaning of said word through said dictionary;

14. The apparatus for reviewing a word in the playback of an audio data in recited in claim 13 further comprises a display means.

15. The apparatus for reviewing a word in the playback of an audio data in recited in claim 13 further comprises a control means for repeating the playback of said word.

16. The apparatus for reviewing a word in the playback of an audio data in recited in claim 13 further comprises a control means for reviewing words adjacent to said word.

17. The apparatus for reviewing a word in the playback of an audio data in recited in claim 13 wherein said storing means that stores said dictionary of words resides remotely in a different location.
